(19) United States
(12) Patent Application Publication
(10) Pub. No.: US 2005/0065284 A1
(43) Pub. Date: Mar. 24, 2005

(54) Novel latex compositions for deposition on various substrates

(76) Inventor: Venkataram Krishnan, Cary, NC (US)

Correspondence Address: MYERS BIGEL SIBLEY & SAJOVEC, PO BOX 37428, RALEIGH, NC, 27627, US

(21) Appl. No.: 10/994,838

(22) Filed: Nov. 22, 2004

Related U.S. Application Data
(62) Division of application No. 10/100,331, filed on Mar. 18, 2002.
(62) Division of application No. 09/370,395, filed on Aug. 6, 1999, now abandoned.

(51) Int. Cl. C08L 9/00

(52) U.S. Cl. 525/87; 524/555; 524/815; 524/458

(57) ABSTRACT

A cationic polymer latex comprises at least one ethylenically unsaturated monomer, an ethylenically unsaturated cationic monomer, and a component which is incorporated into the cationic polymer latex to provide steric stabilization to the cationic polymer latex.

### RELATED APPLICATIONS

This application claims priority to U.S. patent application Ser. No. 10/100,331 filed Mar. 18, 2002, U.S. patent application Ser. No. 09/370,395 filed Aug. 6, 1999 and U.S. Provisional Application No. 60/095,660 filed Aug. 7, 1998, the disclosures of which are incorporated herein by reference in their entireties.

### FIELD AND BACKGROUND OF THE INVENTION

The invention generally relates to polymer latices, and is especially concerned with polymer latices which may be uniformly deposited onto the surface of a substrate.

The deposition of polymer latices on solid substrates (e.g., inorganic or organic fillers, pigments, particles, and the like) has been known for some time so as to impart certain end use performance properties such as, for example, hydrophobicity, strength, compatibility, and the like to the substrates. The polymer latices have typically been anionic, but cationic latices have also been used. Anionic polymer latices may be deposited on negatively-charged fibers by using a retention aid (e.g., alum or a water-soluble cationic polymer). A water-soluble cationic polymer may be employed since it is able to facilitate the deposition of the latex onto a fiber surface. The process of using a retention aid involves depositing an anionic latex onto fibers which are typically cellulosic or wood fibers. This process is known as beater addition. For the most part, the beater addition process generally depends on the flocculation of an anionic latex on fibers through the use of the retention aid. Another process for depositing anionic polymer latices on fibers is known as the saturation process. In this saturation process, a premade fiber web is saturated with the anionic latex.

Several problems exist with respect to the above procedures. With respect to the beater addition process, the latex is flocculated on the fibers in an indiscrete manner, and as a result physical properties relating to strength, resiliency, water repellency, and surface coverage may not be sufficiently imparted to a fibrous structure such as a mat or composite made therefrom. With respect to the saturation process, the coating of the fibers is typically inefficient since the anionic latex often does not uniformly cover the fibers. As a result, a sizeable quantity of latex may be needed to penetrate and saturate the fiber web. Moreover, because the deposition of the anionic latex is often non-uniform, physical properties may not be consistent throughout the fiber web. This physical property inconsistency may become magnified at low latex add-on levels.

As referred to above, it has also been known to deposit cationic polymer latices on fiber surfaces. These cationic polymer latices usually contain low molecular weight cationic surfactants. The use of these surfactants, however, is becoming less desirable due to heightened environmental concerns. In particular, the surfactants may be potentially toxic in aquatic systems.

In view of the above, it is an object of the present invention to provide a cationic polymer latex for deposition on a fiber surface which addresses the problems noted above. In particular, it would be desirable to obviate the need for using retention aids and conventional cationic surfactants in the deposition of cationic polymer latices on fibers. Moreover, it would be desirable if the cationic polymer latex used in the deposition could be employed in relatively low amounts.

### SUMMARY OF THE INVENTION

In one aspect, the invention provides a cationic polymer latex composition. The latex composition comprises an ethylenically unsaturated monomer, an ethylenically unsaturated cationic monomer, and a component which is incorporated into the cationic polymer latex to provide steric stabilization to the cationic polymer latex. The cationic polymer latex composition preferably has a solids content of no less than about 35 weight percent solids, and more preferably no less than about 40 weight percent solids.

### DETAILED DESCRIPTION OF THE PREFERRED EMBODIMENT

The invention will now be described in greater detail with respect to the embodiments and examples illustrated hereinbelow. It should be understood, however, that these embodiments and examples are for illustrative purposes only, and do not limit the scope of the invention as defined by the claims.

Various ethylenically unsaturated monomers may be used in the latex. Examples of monomers can be found in U.S. Pat. No. 5,830,934 to Krishnan, the disclosure of which is incorporated herein by reference in its entirety. Such monomers include, but are not limited to, vinyl aromatic monomers (e.g., styrene, para methyl styrene, chloromethyl styrene, vinyl toluene); olefins (e.g., ethylene); aliphatic conjugated diene monomers (e.g., butadiene); non-aromatic unsaturated mono- or dicarboxylic ester monomers (e.g., methyl methacrylate, ethyl acrylate, butyl acrylate, butyl methacrylate, glycidyl methacrylate, isodecyl acrylate, lauryl acrylate); monomers based on the half ester of an unsaturated dicarboxylic acid monomer (e.g., monomethyl maleate); unsaturated mono- or dicarboxylic acid monomers and derivatives thereof (e.g., itaconic acid); and nitrogen-containing monomers (e.g., acrylonitrile, methacrylonitrile, acrylamide, methacrylamide, N-methylol acrylamide, N-(isobutoxymethyl)acrylamide); vinyl ester monomers which includes branched vinyl esters (e.g., vinyl neodecanoate, vinyl versatates), and monomers containing ethylenic unsaturation such as vinyl acetate and other like monomers. Fluorinated analogs of alkyl acrylates or methacrylates may also be used. Mixtures of the above may be used.

The latex preferably comprises from about 70 to about 99 percent of the ethylenically unsaturated monomer based on the total monomer weight.

The latex also includes an ethylenically unsaturated cationic monomer. For the purposes of the invention, the term “cationic monomer” refers to any monomer which possesses a net positive charge. This positive charge may be imparted by a heteroatom which is present in the monomer. Exemplary heteroatoms include, but are not limited to, nitrogen, sulfur, and phosphorus. The cationic monomer is incorporated into the latex polymer by virtue of its ethylenic unsaturation. Examples of cationic monomers include amine and amide monomers, and quaternary amine monomers. Amine and amide monomers include, but are not limited to: dimethylaminoethyl acrylate; diethylaminoethyl acrylate; dimethyl aminoethyl methacrylate; diethylaminoethyl methacrylate; tertiary butylaminoethyl methacrylate; N,N-dimethyl acrylamide; N,N-dimethylaminopropyl acrylamide; acryloyl morpholine; N-isopropyl acrylamide; N,N-diethyl acrylamide; dimethyl aminoethyl vinyl ether; 2-methyl-1-vinyl imidazole; N,N-dimethyl-aminopropyl methacrylamide; vinyl pyridine; vinyl benzyl amine; and mixtures thereof.

Quaternary amine monomers which may be used in the latex of the invention can include those obtained from the above amine monomers such as by protonation using an acid or via an alkylation reaction using an alkyl halide. Examples of quaternary amine monomers include, but are not limited to: dimethylaminoethyl acrylate, methyl chloride quarternary; dimethylaminoethyl methacrylate, methyl chloride quarternary; diallyldimethylammonium chloride; N,N-dimethylaminopropyl acrylamide, methyl chloride quaternary; trimethyl-(vinyloxyethyl) ammonium chloride; 1-vinyl-2,3-dimethylimidazolinium chloride; vinyl benzyl amine hydrochloride; and vinyl pyridinium hydrochloride. Mixtures of the above may also be used.

Amine salts can also be used and are obtained, for example, by the reaction of an epoxy group with a secondary amine and subsequent neutralization of the newly formed tertiary amine with an acid. An example of this is the reaction product of glycidyl methacrylate with a secondary amine that can be free radically polymerized. Quaternary amine functionality can also be generated as a post reaction on a preformed polymer having, for example, an epoxy group. Examples of these kinds of reactions are described in the article, “Polymer Compositions for Cationic Electrodepositable Coatings, Journal of Coatings Technology, Vol 54, No 686, March 1982. It should also be appreciated that cationic functionality can also be imparted via sulfonium or phosphonium chemistry examples of which are described in the above article.

The latex preferably comprises from about 0.5 to about 15 percent of the cationic monomer based on the total monomer weight.

The latex also comprises a component which is incorporated into the cationic polymer latex to sterically stabilize the latex. Suitable components include, but are not limited to, monomers, polymers, and mixtures thereof as set forth below. For the purposes of the invention, the term “incorporated” with respect to the use of the monomer can be interpreted to mean that the monomer attaches to the backbone of the cationic polymer. The polymer which is “incorporated” into the latex can be interpreted to mean that it is adsorbed or grafted onto the latex surface, an example of which may be polyvinyl alcohol. This stabilizing component may encompass a nonionic monomer or polymer which incorporates steric stabilization to the latex particle without affecting the deposition characteristics of the cationic polymer latex. Exemplary monomers that can be used as steric stabilizers include, but are not limited to, those which contain alkoxylated (e.g., ethoxylated or propoxylated) functionality. Examples of such monomers include those described by the formulas:
(a) CH₂═C(R)COO(CH₂CHR′O)ₙR″—where R═H, C₁-C₄ alkyl; and R′═H, C₁-C₄ alkyl, and R″═H, C₁-C₄alkyl, and n=1-30; (b) CH₂═C(R)COO(CH₂CH₂O)ₙ(CH₂CHR′O)ₘR″—where R═H, C₁-C₄ alkyl, and R′═H, C₁-C₄ alkyl, and R″=H, C₁-C₄ alkyl, n and m each may range from 1-15; and (c) CH₂═C(R)COO(CH₂CHR′O)ₙ(CH₂CH₂O)ₘR″—where R═H, C₁-C₄ alkyl, and R′═H, C₁-C₄alkyl and R″═H, C₁-C₄ alkyl, n and m=1-15. Preferably, CH₃ is employed for the above ranges defined by C₁-C₄ alkyl.

Ethoxylated mono- and diesters of diacids such as maleic and itaconic acids can also be used to achieve the same stabilizing effect. Also acrylate, methacrylate, vinyl and allyl versions of surfactants or polymerizable surfactants as they are commonly named can also be used. Examples of these are TREM LF-40 sold by Henkel of Dusseldorf, Germany, and SAM 186 N sold by BASF of Mount Olive, N.J. These surfactants are characteristic in that they possess ethylenic unsaturation that allows the surfactants to be incorporated into the latex polymer. Similar to other surfactants, these materials have hydrophobic and hydrophilic functionality that varies. Surfactants that are particularly applicable to the present invention are nonionic surfactants wherein the hydrophilic character is believed to be attributable to the presence of alkylene oxide groups (eg: ethylene oxide, propylene oxide, butylene oxide, and the like). The degree of hydrophilicity can vary based on the selection of functionality.

Polymers can also be used to provide steric stability and these are known in the art as protective colloids. Examples of these materials include, but are not limited to, polyvinyl alcohols, polyvinyl pyrollidone, hydroxyethyl cellulose, and the like. Mixtures of any of the above monomers and polymers may also be used. Other monomers and polymers which may be used to impart stability are listed in U.S. Pat. No. 5,830,934 to Krishnan et al.

The component which is used to stabilize the latex is present in an amount ranging from about 0.5 to about 15 percent based on the total weight of the monomers.

The latex of the invention also includes a free radical initiator, the selection of which is known in the art. Preferably, a free radical initiator is used which generates a cationic species upon decomposition and contributes to the cationic charge of the latex. An example of such an initiator is 2,2′-azobis(2-amidinopropane)dihydrochloride) sold commercially as Wako V-50 by Wako Chemicals of Richmond, Va.

The latex of the invention may also include other additives to improve the physical and/or mechanical properties of the polymer, the selection of which are known to one skilled in the art. These additives include processing aids and performance aids such as, but are not limited to, crosslinking agents, natural and synthetic binders, plasticizers, softeners, foam-inhibiting agents, froth aids, flame retardants, dispersing agents, pH-adjusting components, sequestering or chelating agents, and other components.

In another aspect, the invention relates to a treated fibrous material. The treated fibrous material comprises at least one fiber and a cationic polymer latex described herein positioned on the fiber. If desired, the polymer may be applied to the fiber in the form of a powder. The composition may be deposited on the fiber by methods known to one skilled in the art.

For the purposes of the invention, the term “fiber” is to be broadly construed and may include single or multiple filaments that may be present in a variety of ways. One should appreciate that only a single fiber can be treated by the cationic polymer latex of the invention if so desired. The fibers used in the invention may encompass natural and/or synthetic fibers. For example, natural fibers include, but are not limited to, animal fibers (e.g., silk, wool); mineral fibers (e.g., asbestos); and vegetable-based fibers (e.g., cotton, flax, jute, and ramie). Cellulosic and wood fibers may also be used. Examples of synthetic fibers include, but are not limited to, those made from polymers such as polyamides, polyesters, acrylics, and polyolefins. Other examples of fibers include, but are not limited to, rayon and inorganic substances extruded in fibrous form such as glass, boron, boron carbide, boron nitride, carbon, graphite, aluminum silicate, fused silica, and metals such as steel. Recycled fibers using any of the above materials may also be employed. Mixtures of the above fibers may be used.

The treated fibrous material may have at least one polymeric layer deposited on the fiber so as to form a composite fibrous structure. Multiple polymer layers may be used as desired by one skilled in the art. As an example, anionic polymer latices may be deposited on the treated fibrous material to enhance specific properties of the treated fibrous material. Thus, unique fibers with specially modified surfaces can conceivably be made in accordance with the invention.

The invention also provides an article of manufacture comprising a substrate and a cationic polymer latex deposited and positioned thereon as defined herein. The cationic polymer latex may be in the form of a powder if so desired. For the purposes of the invention, the term “substrate” is to be broadly interpreted and include all those formed from inorganic materials, organic materials, and composites thereof. The substrate can encompass, but certainly is not limited to, fibers, fillers, pigments, and the like, as well as other organic and inorganic materials. Preferably, a fibrous substrate is employed. The term “fibrous substrate” is to be broadly interpreted to include the fibers described herein. The fibrous substrate may be present in the form of web, yarn, fabric, and the like. The fibrous substrate can be in the form of a textile substrate. For the purposes of the invention, the term “textile substrate” is similar to that defined in U.S. Pat. No. 5,403,640 to Krishnan et al., the disclosure of which is incorporated herein by reference in its entirety. For example, “textile substrate” can be interpreted to encompass a fiber, web, yarn, thread, sliver, woven fabric, knitted fabric, non-woven fabric, upholstery fabric, tufted carpet, pile carpet, and the like, formed from any of the fibers described herein. The article of manufacture can be made in accordance with known procedures. The invention also provides a coated material comprising a material having a cationic polymer latex deposited. For the purposes of the invention, the term material refers to, but is not limited to, a fiber, filler, particle, pigment, composites thereof, and the like. These materials may be organic, inorganic, or a composite of both as described herein.

Other layers of polymers may be deposited on the cationic polymer latex which is present in the article of manufacture to form a composite structure. For example, the deposited cationic latices can be followed by the deposition of anionic latices or other polymers to enhance specific properties of the article of manufacture. Unique fibers which comprise the fibrous substrate with specially modified surfaces can be made in accordance with the invention.

A multiple deposition process can also be used to make composite films that have applications in areas other than textile articles. For example, the cationic latices of the invention can also be used to make multilayer elastomeric gloves. Cellulosic structures can also be made by the cationic latices of the invention which encompasses, but is not limited to, cellulosic composites and heavy duty cellulosic structures. Examples of cellulosic composites include those relating to filtration, shoe insole, flooring felt, gasketing, as well as other applications. Heavy duty cellulosic structures include, but are not limited to, dunnage bags, and industrial wipes. Other areas of use for this technology include, but are not limited to, flocculants, wet and dry strength additives for papermaking, retention aids, cement modifications, dye fixation, redispersible powders, and the like.

The invention is advantageous in many respects. An especially desirable feature of the invention is that the cationic latices may be completely deposited on a substrate such that residual latex does not remain in the processing fluid medium, which is potentially advantageous from an environmental standpoint. The cationic latices can be preferentially deposited on a substrate that has a net negative charge, and can be deposited in a uniform manner which uses less latex (e.g., less than 5 percent). Preferably, the cationic latices can deposit on the substrate surface as a monolayer. The cationic latices may be formed by existing emulsion polymerization processes. Such processes advantageously allow for the preparation of high molecular weight polymers. The cationic polymers latices of the invention also obviate the need for retention aids and cationic surfactants. Most preferably, the cationic polymers latices are devoid of cationic surfactants. This is particularly desirable, since these materials are potentially toxic in aquatic environments. Thus, the polymer latex of the invention is more environmentally friendly. Moreover, if desired, the polymer latices may be devoid of conventional surfactants, e.g., nonionic surfactants. The latices are also clean. For the purpose of the invention, the term “clean” refers to the latices having preferably less than about 0.1 percent coagulum and/or preferably less than about 50 ppm grit on a 200 mesh screen and more preferably less than 10 ppm grit. The polymer latices of the invention also exhibit high performance properties.

The following examples are intended to illustrate the invention, and is not meant as a limitation thereon.

### EXAMPLE 1

The cationic latex of the invention can be made by a batch or semicontinuous process. The procedure outlined below is for a batch process. A solution was made by dissolving 105 gms of methoxy polyethyleneglycol methacrylate, 30 gms of polymerizable surfactant (e.g., SAM 186N), 62.5 gms of N-methylol acrylamide (48% active), and 60 gms dimethylaminoethyl methacrylate in 2600 gms of deionised water. The pH of the solution was adjusted to about 4 with 36.5 gms hydrochloric acid (37% active) and this solution was then charged into a 1 gallon reactor. The reactor was purged several times with nitrogen and a mixture of 900 gms styrene and 405 gms butadiene was added into the reactor. The temperature was then raised to about 140° C. and 6 gms of the cationic initiator Wako V-50 was injected into the reactor as a solution in 45 gms of deionised water. The reaction is continued until the monomer conversion is greater than 95 percent. The temperature is raised as needed to obtain a total reaction time of about 9-11 hours. The latex may also be stripped to a desired content, usually to about 40 percent.

### EXAMPLE 2

To a four necked 1-liter flask, 690 gms of deionized water (DW) and 12 gms DMAEMA was charged. The pH was adjusted to approximately 4.0 with concentrated hydrochloric acid (37% active). 12 gms MPEG 550, 3 gms SAM 186N, 6 gms Abex 2525 (50% active) was then added along with an initial monomer charge of 60 gms MMA and 60 gms BA. The temperature was raised to 70° C. and 1.2 gms of Wako V-50 was then injected. After about 50 percent conversion of the initial monomer was achieved, the feeds were initiated. The feeds comprised: (1) 222 gms MMA and 174 gms BA which was fed over 5 hrs; (2) an aqueous feed of 60 gms DW, 30 gms MPEG 550, 37.5 gms NMA (48% active), and 9 gms SAM 186N which was fed over 3 hrs; (3) a cationic monomer feed of 12 gms DMAEMA, 7.3 gms HCl, and 60 gms DW that was fed over 3 hrs; and (4) a catalyst feed of 120 gms DW and 1.2 gms of Wako V-50 that was fed over 5.5 hrs. The temperature was gradually raised to 85° C. over 6 hrs and the reaction was carried to complete conversion. The latex had a final solids content of 38.1 percent at a pH of 4.5. The coagulum in the final latex was negligible (i.e., less than 0.05 percent) and the grit in the latex was 28 ppm on a 200 mesh screen.

### EXAMPLE 3

The procedure according to Example 2 was employed except that the monomer composition was changed. The latex had the following monomer composition (gms): STY/MMA/BA/DMAEMA/MPEG 550/NMA (48% active)=60/300/156/24/42/37.5. The latex had a final solids content of 39 percent at a pH of 4.4. The coagulum in the latex was negligible and the grit on a 200 mesh screen was 97 ppm.

### EXAMPLE 4

The procedure according to Example 3 was employed except that the monomer composition was different. The latex had the following monomer composition (gms): STY/BA/DMAEMA/MPEG 550/NMA (48% active)=432/96/24/30/37.5. Also, this recipe had no Abex 2525 but instead used 15 gms of SAM 186N in the aqueous surfactant feed in addition to 3 gms in the initial batch. Also, the level of V-50 initiator was increased from 1.2 gms to 1.8 gms in the catalyst feed. The latex had a final solids content of 40.3 percent at a pH of 4.3. The coagulum in the latex was negligible and the grit on a 200 mesh screen was 48 ppm.

### EXAMPLE 5

The process is a batch process and is similar to that described in Example 1 with the following monomer composition (gms): DMAEMA/NMA (48% active)/AN/STY/BD/MPEG 550=75/62.5/255/150/915/75. In addition, the latex had 37.5 gms of polymerizable surfactant (SAM 186-N). The final latex before stripping had a solids content of 34.3 percent and a pH of 4.8 at a viscosity of 44 cps. The latex was very clean and had no coagulum and the grit on a 200 mesh screen was negligible (less than 2 ppm). This latex also did not use conventional surfactant, e.g., Abex 2525.

### EXAMPLES 6-11

Comparative Examples Latices were prepared according to R. H. Ottewill, A. B. Schofield, J. A. Waters, N. St. J. Williams “Preparation of core-shell polymer colloid particles by encapsulation”, Colloid Polym Sci 275: 274-283, (1997). Ottewill et al. is primarily interested in looking at forming core-shell latex particles by encapsulation of a cationic latex with an anionic latex. Example 6 represents a latex prepared according to Ottewill et al. Examples 7-11 represent variations of the procedure of Example 6. Nonetheless, none of the latices that were prepared according to Examples 6-11 were clean (as defined herein) and commercially viable.

### EXAMPLE 6

A latex according to a procedure proposed by Ottewill et al. was formed from the following recipe:

| Ingredient | gms |
|---|---|
| n-butyl methacrylate | 543 |
| Wako V-50 | 4.8 |
| polyethyleneglycol methacrylate | 57 |
| (Bisomer S10W)(MW = 2000) | |
| sodium chloride | 18 |
| deionized water | 5400 |

The latex was polymerized at 70° C. When the experiment was repeated according to Ottewill, the latex had a final solids content of 9.9 percent, a pH of 5.0, a coagulum of 2.6 percent and grit on a 200 mesh screen of 86 ppm. The particle size of the latex was 603 nm.

### EXAMPLE 7

The procedure of Example 6 was repeated except that MPEG 550 (MW=550) replaced S10W. A latex with a much higher coagulum, about 23.4 percent, resulted.

### EXAMPLE 8

The procedure of Example 6 was repeated except that 1080 gms of deionized water was employed instead of 5400. This change was carried out in order to increase the solids content of the latex, which was between 36 and 37 percent. Nonetheless, the entire latex coagulated.

### EXAMPLE 9

The procedure of Example 6 was repeated at a much lower salt concentration, because salt concentration is believed to affect stability and particle size. Using 1.2 gms sodium chloride in the above recipe, a latex of 1.6 percent coagulum with a particle size of approximately 283 nm, and grit on a 200 mesh screen of 58 ppm resulted.

### EXAMPLE 10

20 The procedure of Example 9 was repeated using 1080 gms water to attempt to achieve a latex with a higher solids content. Although the latex achieved a higher solids content (33.3 percent), the latex had 1.8 percent coagulum and grit on a 200 mesh screen of 84 ppm.

### EXAMPLE 11

The procedure outlined in Example 6 was employed, except that the following recipe was used:

| Ingredient | gms |
|---|---|
| deionized water | 1080 |
| Wako V-50 | 4.8 |
| styrene | 372 |
| butadiene | 171 |
| Bisomer S10W | 57 |
| sodium chloride | 1.2 |

The composition was polymerized at 70° C. This recipe is designed for comparison to the procedure for making a styrene/butadiene latex described in Example 1. When this recipe is used using the procedure of Example 6, it results in complete coagulation of the latex, i.e., the entire latex destabilized.

### EXAMPLE 12

Addition of Cationic Monomer The procedure of Example 11 was repeated except that 24 gms of a cationic monomer (e.g., dimethyl aminoethyl methacrylate methyl chloride quaternary, FM1Q75MC) is added in place of 24 gms of the butadiene charge. The resulting latex is much cleaner and there is about 2.5 percent coagulum and 96 ppm grit on a 200 mesh screen at a final solids of 34.4 percent. Thus, the addition of a cationic monomer to an Ottewill, et al recipe significantly improves its stability.

### EXAMPLE 13

The procedure of Example 11 was repeated using 3 gms salt and cationic monomer described in Example 12 and MPEG 550 in place of Bisomer S10W. The latex has trace amounts of coagulum and 14 ppm grit at a solids content of 34.9 percent. Thus, the use of steric stabilizing monomer clearly helps to significantly improve the stability and cleanliness of the latex.

### EXAMPLES 14-17

### Cationic Polymer Latices

Examples 14-17 represent various cationic polymer latices. These examples are intended to show the importance of the steric stabilizing mechanism and its ability to impart stability to the latex. One can use polymerizable components such as, for example, MPEG 550 and SAM 186N or conventional nonionic surfactants such as, for example, Abex 2525.

### EXAMPLE 14

A latex was made according to the procedure outlined in Example 1 with the following monomer composition (gms): NMA (48% active) /STY/BD/DMAEMA=62.5/930/480/60. The temperature of the polymerization was 70° C. The resulting latex had a 4.15 percent coagulum and a grit level of 130 ppm on a 200 mesh screen at a solid content of 32.4 percent. The latex is believed to be not clean without employing steric stabilizing monomers such as MPEG 550 and SAM 186N.

### EXAMPLE 15

The procedure according to Example 14 was repeated except that the butadiene level was reduced to 420 gms, 60 gms of SAM 186N was added, and 7.5 gms of Abex 2525 (50% active), a conventional non-ionic surfactant, was employed. The resulting latex had no coagulum and 28 ppm grit at a solids content of 33.6 percent.

### EXAMPLE 16

The procedure according to Example 15 was repeated using half the amount of SAM 186 N. The resulting latex was not as clean and had a coagulum of 0.7 percent and grit of 114 ppm at a solids content of 33.8 percent.

### EXAMPLE 17

The procedure according to Example 16 was repeated using 105 gms of MPEG 550 and 345 gms of butadiene without the Abex 2525. The resulting latex is much cleaner with only 0.2 percent coagulum and 26 ppm grit at a solids level of 34.1 percent. The butadiene level in this case was set to compensate for the additional MPEG 550.

### EXAMPLES 18-20

### Effect of Conventional Surfactants on Stability of Polymer Latices

Examples 18-20 illustrate the effect of using a conventional nonionic surfactant on latex stability. While helpful, these materials may not be adequate in the amounts used to impart stability on their own. The latices are believed to be more stable when used in conjunction with the polymerizable surfactants as shown in the earlier examples,

### EXAMPLE 18

A latex was made according to the procedure outlined in Example 1 with the following monomer composition (gms): NMA (48% active)/STY/BD/DMAEMA=62.5/930/480/60. 30 gms of Abex 2525 (50% active) was employed, along with 7.5 gms of initiator Wako V-50.

The temperature of the polymerization was 70° C. The resulting latex had a 2.6 percent coagulum and a solids content of 33.5 percent.

### EXAMPLE 19

25 The procedure according to Example 18 was carried out except that the level of Abex 2525 was increased to 45 gms. The resulting latex was still not clean.

### EXAMPLE 20

The procedure according to Example 18 was carried out except that dimethylaminoethyl methacrylate was replaced by its quaternary version (FM1Q75MC). The resulting latex produced less coagulum (1.27 percent), but was still considered unacceptable.

### EXAMPLE 21

A latex was made according to the procedure of Example 4 with the following monomer composition (gms): FM1Q75MC/NMA (48% active)/STY=30/37.5/552.

The recipe was polymerized at 70° C. The latex made according to this recipe had a final solids content of 26.1 percent, a pH of 5, and a viscosity of 18 cps. The coagulum amount was 2.39 percent. This example is intended to demonstrate that without employing steric stabilizing monomers, a clean latex could not be attained even at this solids content.

### EXAMPLES 22-25

### Comparative Data—Beater Addition Process

Table 1 illustrates comparative data of various paper samples having latex added thereon via a beater addition process. Example 22 represents a sample without latex. Example 23 represents a sample with a commercially available anionic latex having a 52/48 styrene to butadiene ratio. Examples 24 and 25 represent samples using cationic latices prepared according to the procedure of Example 1. As seen, the samples using the latices of the invention generally display superior physical properties to Examples 22 and 23.

### EXAMPLES 26-28

### Comparative Data—Saturation Process

Table 2 illustrates comparative data of various paper samples having latex added thereon via a saturation process. Example 26 represents a sample with a commercially available anionic latex having a 55/45 styrene to butadiene ratio. Examples 27 and 28 represent samples using cationic latices prepared according to the procedure of Example 1. As seen, the samples using the latices of the invention exhibit good physical properties relative to Example 26 while employing a much lower amount of latex.

### EXAMPLES 29-33

### Comparative Data—Saturation Process

Table 3 illustrates comparative data of various paper samples having latex added thereon via a saturation process. Example 29 represents a sample without latex. Examples 30 and 31 represent samples using commercially available anionic latices having 40/60 and 55/45 styrene to butadiene ratios respectively. Examples 32 and 33 represent samples using cationic latices prepared according to the procedure of Example 1. As seen, the samples using the latices of the invention exhibit superior physical properties relative to Examples 29 through 31 while employing a much lower amount of latex.

TABLE 1
CATIONIC LATICES
Comparison with Anionic Latices - Beater Addition Process

| | | Styrene/ | Reichhold | Reichhold |
|---|---|---|---|---|
| | (22) | Butadiene | Cationic | Cationic |
| Example | dry control | 52/48 (23) | (24) | (25) |
| Tg of polymer, | | −19 | −31 | −31 |
| degree C. | | | | |
| Latex Add-on, % | 0 | 10 | 5 | 10 |
| Tensile, lb. | 32.3 | 40.9 | 112.1 | 130.7 |
| Tensile, psi | 807 | 1021 | 2799 | 3268 |
| Tensile Index | — | 102 | 560 | 327 |
| Wet Tensile - 1 | — | 179 | 1219 | 1983 |
| hour, psi | | | | |
| Wet Tensile - 6 | — | 179 | 1012 | 1405 |
| hour, psi | | | | |
| Wet Tensile - 24 | — | 166 | 995 | 1133 |
| hour, psi | | | | |

Notes:
1. 100% Softwoods - bleached sulfite.
2. Tensile Index is PSI/Latex Add-on.
3. Dry Control is Substrate without Latex.

TABLE 2
CATIONIC LATICES
Comparison OF Wet Strength with Anionic Latices - Saturation Process

| | Styrene/Butadiene | Reichhold | Reichhold |
|---|---|---|---|
| | 55/45 | Cationic | Cationic |
| Example | (26) | (27) | (28) |
| Tg of polymer, | −5 | 8 | −31 |
| degree C. | | | |
| Latex Add-on, % | 31.3 | 3.6 | 5.7 |
| Tensile, lb. | 82.8 | 81.2 | 86.1 |
| Tensile, psi | 2267 | 2881 | 3351 |
| Tensile Index | 72 | 800 | 588 |
| Wet Tensile - 1 | 787 | 712 | 1374 |
| hour, psi | | | |
| Wet Tensile - 6 | 909 | 652 | 1150 |
| hour, psi | | | |

Notes:
1. 100% Softwoods - bleached sulfite.
2. Tensile Index is PSI/Latex Add-on.

TABLE 3
CATIONIC LATICES
Comparison with Anionic Latices - Saturation Process

| | | Styrene/ | Styrene/ | | |
|---|---|---|---|---|---|
| | (29) | Butadiene | Butadiene | Reichhold | Reichhold |
| | dry | 40/60 | 55/45 | Cationic | Cationic |
| Example | control | (30) | (31) | (32) | (33) |
| Tg of polymer, | | −36 | −5 | 5 | 8 |
| degree C. | | | | | |
| Latex Add-on, | 0 | 31.3 | 16.3 | 5.4 | 5.9 |
| % | | | | | |
| Basis Weight, | 0.9 | 1.18 | 1.05 | 0.95 | 0.95 |
| lb/yd2 | | | | | |
| Density | 0.55 | 0.59 | 0.56 | 0.54 | 0.54 |
| Tensile, lb. | 39.24 | 83.11 | 80.9 | 112.5 | 128.9 |
| Elongation, % | 2.4 | 10.3 | 7 | 6.5 | 6.5 |
| Tensile, psi | 1060 | 1808 | 1759 | 3136 | 3485 |
| Tensile index | — | 58 | 108 | 581 | 591 |

Notes:
1. Dry Control is substrate without latex.
2. Tensile Index is PSI/Latex Add-on.
3. 50/50 fiber blend of softwoods.

Disclosed herein are typical preferred embodiments of the invention and, although specific terms are employed, they are used in a generic and descriptive sense only and not for purposes of limitation of the scope of the invention.

1. A treated fibrous material comprising:
at least one fiber; and
a cationic polymer latex emulsion positioned on said at least one fiber, said latex comprising at least one ethylenically unsaturated monomer; an ethylenically unsaturated cationic monomer; and a component which is incorporated into the cationic polymer latex to sterically stabilize the latex, said component selected from the group consisting of (a) CH₂═C(R)COO(CH₂CHR′O)ₙR″, where R═H, C₁-C₄ alkyl; and R′═H, C₁-C₄ alkyl, and R″═H, C₁-C₄alkyl, and n=1-30; (b) CH₂═C(R)COO(CH₂CH₂O)ₙ(CH₂CHR′O)ₘR″, where R═H, C₁-C₄ alkyl, and R′═H, C₁-C₄ alkyl, and R″═H, C₁-C₄ alkyl, n and m each may range from l-15; and (c) CH₂═C(R)COO(CH₂CHR′O)ₙ (CH₂CH₂O)ₘR″, where R═H, C₁-C₄ alkyl, and R′═H, C₁-C₄ alkyl and R″═H, C₁-C₄ alkyl, n and m=1-15, and (d) mixtures of (a) and (b); and
optionally up to 1.0 weight percent of a nonionic surfactant;
wherein said latex is devoid of cationic and anionic surfactants.

2. The treated fibrous material according to claim 1, wherein said at least one fiber is selected from the group consisting of cellulose, wood, and mixtures thereof.

3. The treated fibrous material according to claim 1, further comprising at least one polymeric layer positioned on said at least one fiber.

4. An article of manufacture comprising:
a substrate; and
a cationic polymer latex positioned on said substrate, said cationic polymer latex comprising at least one ethylenically unsaturated monomer; an ethylenically unsaturated cationic monomer; and a component which is incorporated into said cationic polymer latex and stabilizes said latex, said component selected from the group consisting of (a) CH₂═C(R)COO(CH₂CHR′O)ₙR″, where R═H, C₁-C₄ alkyl; and R′═H, C₁-C₄ alkyl, and R″═H, C₁-C₄alkyl, and n=1-30; (b) CH₂═C(R)COO(CH₂CH₂O)ₙ (CH₂CHR′O)ₘR″, where R═H, C₁-C₄ alkyl, and R′═H, C₁-C₄ alkyl, and R″═H, C₁-C₄ alkyl, n and m each may range from 1-15; and (c) CH₂═C(R)COO(CH₂CHR′O)ₙ (CH₂CH₂O)ₘR″, where R═H, C₁-C₄ alkyl, and R′═H, C₁-C₄ alkyl and R″═H, C₁-C₄ alkyl, n and m=1-15, and (d) mixtures of (a) and (b); and
optionally up to 1.0 weight percent of a nonionic surfactant;
wherein said latex is devoid of cationic and anionic surfactants.

5. The article of manufacture according to claim 4, wherein said substrate is a fibrous substrate comprising fibers selected from the group consisting of cellulose fibers, wood fibers, and mixtures thereof.

6. The article of manufacture according to claim 4, further comprising at least one polymeric layer positioned on said fibrous substrate.

7. The article of manufacture according to claim 4, wherein said article of manufacture is an elastomeric glove.

8. The article of manufacture according to claim 4, wherein said article of manufacture is a cellulosic structure.

9. The article of manufacture according to claim 4, wherein said substrate comprises at least one material selected from the group consisting of fibers, fillers, pigments, organic materials, and inorganic materials.

10. The article of manufacture according to claim 4, wherein said cationic polymer latex is present as a powder.
